(19) United States
(12) Patent Application Publication
(10) Pub. No.: US 2010/0292846 A1
(43) Pub. Date: Nov. 18, 2010

(54) REFRIGERATOR INCLUDING ICE MAKING DEVICE AND CONTROL METHOD THEREOF

(75) Inventors: Tae Hee LEE, Seoul (KR); Dong Hoon LEE, Seoul (KR); Dong Hoon LEE, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/764,133

(22) Filed: Apr. 21, 2010

(30) Foreign Application Priority Data
May 18, 2009 (KR) 10-2009-0043126

(51) Int. Cl. G05B 15/00

(52) U.S. Cl. 700/275

(57) ABSTRACT

A refrigerator and a control method thereof, in which an ice making speed is controlled. A selected ice-making operation mode may be determined, and, based on the determination of the selected ice-making operation mode, an internal temperature of the ice making compartment may be controlled to an appropriate temperature. For instance, an operation rate of a cold air fan and/or a rotating speed of the cold air fan may be controlled.

This application claims the benefit of Korean Patent Application No. 10-2009-0043126, filed on May 18, 2009, which is hereby incorporated by reference as if fully set forth herein.

### FIELD

The present disclosure relates to a refrigerator including an ice making device and a control method thereof.

### BACKGROUND

A refrigerator is a home appliance for storing food in a refrigerated or frozen state using a refrigerant cycle. Such a refrigerator includes a body having a storage compartment such as a freezing compartment or a refrigerating compartment, and a door mounted to the body, to open or close the storage compartment.

An ice making compartment, in which ice is made and stored, is provided at the storage compartment or door. An ice making device, which includes an ice making tray, is arranged in the ice making compartment. A water supplying device is also arranged in the ice making compartment, to supply water to the ice making tray.

In an ice making operation carried out in the conventional refrigerator, water is supplied to the ice making tray, and is then frozen by cold air introduced into the ice making compartment, thereby forming ice having a particular shape.

After the ice making operation is completed, the ice is separated from the ice making tray as the ice making tray rotates, and is then stored in an ice storage box arranged near the ice making tray. The separation of ice may be achieved using a separate ice separating device.

### SUMMARY

In one aspect, a method controls a refrigerator including a body, an evaporator arranged in the body, a cold air fan configured to move cold air generated around the evaporator, and an ice making compartment, into which cold air from the evaporator is introduced by the cold air fan. The method includes receiving user input selecting an ice-making operation mode from among multiple, different ice-making operation modes that each define a different ice making speed and determining, from among the multiple, different ice-making operation modes, which ice-making operation mode is selected based on the received user input. Based on the determination of the selected ice-making operation mode, an internal temperature of the ice making compartment is controlled to be appropriate for the selected ice-making operation mode by controlling at least one of an operation rate of the cold air fan and a rotating speed of the cold air fan.

Implementations may include one or more of the following features. For example, the method may include receiving user input selecting an ice-making operation mode from among a general ice making mode, a fast ice making mode defined to make ice within a shorter time than the general ice making mode, and a stop ice making mode in which ice making is stopped and, in response to a determination that the general ice making mode is selected, setting the operation rate of the cold air fan to a first operation rate, and setting the rotating speed of the cold air fan to a first rotating speed.

In some implementations, the method may include, in response to a determination that the fast ice making mode is selected, setting the operation rate of the cold air fan to a second operation rate that is higher than the first operation rate. The method also may include determining a variation rate of the internal temperature of the ice making compartment during the fast ice making mode, comparing the variation rate of the internal temperature of the ice making compartment during the fast ice making mode to a predetermined reference range, and controlling at least one of the operation rate of the cold air fan and the rotating speed of the cold air fan based on the comparison.

In some examples, the method may include decreasing the operation rate of the cold air fan when the comparison reveals that the variation rate of the internal temperature of the ice making compartment during the fast ice making mode is higher than the predetermined reference range. The method further may include decreasing the rotating speed of the cold air fan from the set rotating speed when the comparison reveals that the variation rate of the internal temperature of the ice making compartment is higher than the predetermined reference range during the fast ice making mode and increasing the rotating speed of the cold air fan from the set rotating speed when the comparison reveals that the variation rate of the internal temperature of the ice making compartment is lower than the predetermined reference range during the fast ice making mode.

In addition, the method may include, in response to a determination that the fast ice making mode is selected, setting the rotating speed of the cold air fan to a second rotating speed that is higher than the first rotating speed. The method also may include determining a variation rate of the internal temperature of the ice making compartment during the fast ice making mode, comparing the variation rate of the internal temperature of the ice making compartment during the fast ice making mode to a predetermined reference range, and controlling at least one of the operation rate of the cold air fan and the rotating speed of the cold air fan based on the comparison.

In some implementations, the method may include decreasing the rotating speed of the cold air fan from the set rotating speed when the comparison reveals that the variation rate of the internal temperature of the ice making compartment is higher than the predetermined reference range during the fast ice making mode. The method further may include decreasing the operation rate of the cold air fan from the set operation rate when the comparison reveals that the variation rate of the internal temperature of the ice making compartment is higher than the predetermined reference range during the fast ice making mode.

In some examples, the method may include, in response to a determination that the stop ice making mode is selected, setting the operation rate of the cold air fan to a third operation rate that is lower than the first operation rate. The method also may include, in response to a determination that the stop ice making mode is selected, setting the rotating speed of the cold air fan to a third rotating speed that is lower than the first rotating speed. The method further may include, in response to a determination that the fast ice making mode is selected, controlling an internal temperature of the ice making compartment to be −16° C.

In another aspect, a method controls a refrigerator including a cold air fan configured to move cold air from an evaporator, an ice making compartment, into which cold air moved by the cold air fan is introduced, and an ice making device installed in the ice making compartment. The method includes receiving user input selecting from among a first ice making mode, a second ice making mode, and a third ice making mode. The first ice making mode defines a relatively slow ice making speed, the second ice making mode defines a relatively medium ice making speed, and the third ice making mode defines a relatively fast ice making speed. The method also includes determining whether the first ice making mode, the second ice making mode, or the third ice making mode has been selected based on the received user input. In response to a determination that the first ice making mode has been selected, an internal temperature of the ice making compartment is controlled to a first temperature by controlling an operation rate of the cold air fan to be a first operation rate and controlling a rotating speed of the cold air fan to be a first rotating speed. In response to a determination that the second ice making mode has been selected, the internal temperature of the ice making compartment is controlled to a second temperature that is lower than the first temperature by controlling the operation rate of the cold air fan to be a second operation rate and controlling the rotating speed of the cold air fan to be a second rotating speed. In response to a determination that the third ice making mode has been selected, the internal temperature of the ice making compartment is controlled to a third temperature that is lower than the second temperature by controlling the operation rate of the cold air fan to be a third operation rate and controlling the rotating speed of the cold air fan to be a third rotating speed.

Implementations may include one or more of the following features. For example, the method may include receiving user input selecting from among a stop ice making mode, a general ice making mode, and a fast ice making mode. In addition, the first operation rate, the second operation rate, and the third operation rate may be the same, the first rotating speed may be slower than the second rotating speed, and the second rotating speed may be slower than the third rotating speed.

Further, the first rotating speed, the second rotating speed, and the third rotating speed may be the same, the first operation rate may be lower than the second operation rate, and the second operation rate may be lower than the third operation rate. The second rotating speed and the third rotating speed may be the same, the first rotating speed may be slower than the second rotating speed and the third rotating speed, the first operation rate and the second operation rate may be the same, and the first operation rate and the second operation rate may be lower than the third operation rate.

In yet another aspect, a method controls a refrigerator including a cold air fan configured to move cold air from an evaporator, an ice making compartment, into which cold air moved by the cold air fan is introduced, and an ice making device installed in the ice making compartment. The method includes decreasing an internal temperature of the ice making compartment to promote faster ice making by controlling at least one of an operation rate of the cold air fan and a rotating speed of the cold air fan. The method also includes determining a variation rate of the internal temperature of the ice making compartment while decreasing the internal temperature of the ice making compartment to promote faster ice making and comparing the variation rate of the internal temperature of the ice making compartment while decreasing the internal temperature of the ice making compartment to promote faster ice making to a predetermined reference range. The method further includes adjusting at least one of the operation rate of the cold air fan and the rotating speed of the cold air fan based on the comparison of the variation rate of the internal temperature of the ice making compartment while decreasing the internal temperature of the ice making compartment to promote faster ice making to the predetermined reference range.

Implementations may include decreasing the rotating speed of the cold air fan when the comparison reveals that the variation rate of the internal temperature of the ice making compartment is higher than the predetermined reference range and increasing the rotating speed of the cold air fan when the comparison reveals that the variation rate of the internal temperature of the ice making compartment is lower than the predetermined reference range.

The details of one or more implementations are set forth in the accompanying drawings and the description, below. Other potential features and advantages of the disclosure will be apparent from the description and drawings, and from the claims.

### BRIEF DESCRIPTION OF THE DRAWINGS

FIG. 1 is a perspective view of a refrigerator;

FIG. 2 is a control block diagram of the refrigerator;

FIG. 3 is a flow chart illustrating a method for controlling the refrigerator;

FIG. 4 is a waveform diagram illustrating operation rates of a cold air fan in a general ice making mode, a fast ice making mode, and an ice-making stop mode;

FIG. 5 is a graph depicting a variation in the internal temperature of an ice making compartment;

FIG. 6 is a graph depicting a variation in the rotating speed of a cold air fan; and

FIG. 7 is a flow chart illustrating a method for controlling the refrigerator.

### DETAILED DESCRIPTION

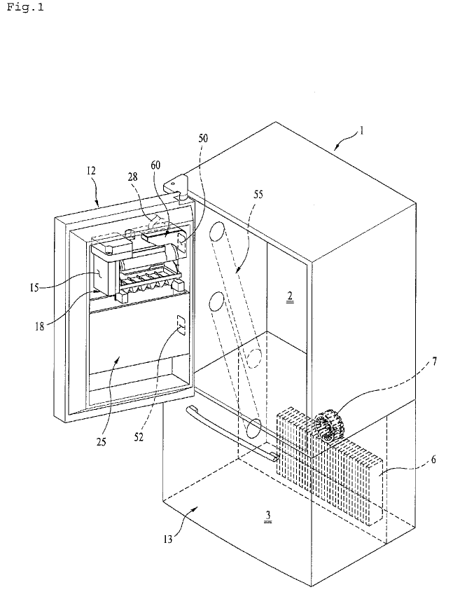

FIG. 1 illustrates an example refrigerator. As shown in FIG. 1, the refrigerator includes a body 1 having a refrigerating compartment 2 and a freezing compartment 3, a refrigerating compartment door 12 pivotally mounted to the body 1, to open or close the refrigerating compartment 2, and a freezing compartment door 13 slidably mounted to the body 1, to open or close the freezing compartment 3.

In the illustrated example, the refrigerating compartment 2 is arranged at an upper portion of the body 1, and the freezing compartment 3 is arranged at a lower portion of the body 1. However, other arrangements are possible. For example, the freezing compartment 3 may be arranged at the upper portion of the body 1. In addition, a side-by-side type structure, in which the refrigerating compartment 2 and freezing compartment 3 are horizontally arranged in parallel, may be applied.

An ice making compartment 15 is provided at a back surface of the refrigerating compartment door 12. Installed in the ice making compartment 15 are an ice making device 18 to make ice, and an ice storage box 25 to store ice separated from the ice making device 18.

The ice making device 18 includes an ice making tray to receive water therein, and a driving unit connected to the ice making tray, to rotate the ice making tray, or to drive an ice separating heater.

A water supply hose 28 is arranged over the ice making tray, to supply water to the ice making tray.

A cold air inlet 50 is provided at one side wall of the ice making compartment 15, to introduce cold air into the ice making compartment 15. A guide unit 60 guides cold air entering through the cold air inlet 50 over the ice making device. A cold air outlet 52 is also provided at the side wall of the ice making compartment 15, to discharge the cold air from the ice making compartment 15.

The cold air inlet 50 and cold air outlet 52 are connected to a cold air guide duct 55 installed in a side wall of the body 1.

The cold air guide duct 55 functions not only to feed the cold air from the freezing compartment 3 arranged at the lower portion of the body 1 to the ice making compartment 15, but also to again feed the cold air from the ice making compartment 15 to the freezing compartment 3.

In detail, when cold air is generated around an evaporator 6 arranged at the rear of the freezing compartment 3, a major part of the cold air is introduced into the freezing compartment 3. The remaining part of the cold air is fed to the ice making compartment 15 by being guided by the cold air guide duct 55.

Such a cold air flow is effected by a cold air fan 7. The amount of cold air introduced into the ice making compartment 15 may be controlled in accordance with the rotating speed of the cold air fan 7 or the operation rate (on/off ratio) of the cold air fan 7.

When the amount of cold air introduced into the ice making compartment 15 per unit time is varied, the internal temperature of the ice making compartment 15 may be varied, and the temperature variation rate thereof may also be varied. The ice making rate may be controlled in accordance with the temperature variation or the variation in the temperature variation rate.

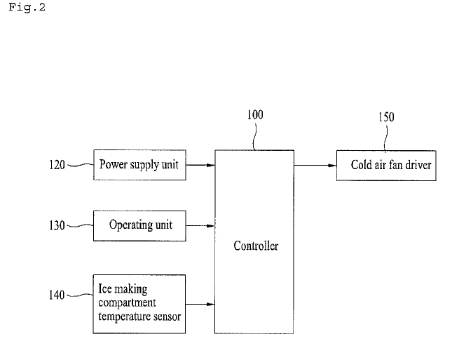

FIG. 2 illustrates an example refrigerator control system. A controller 100, which is provided at the refrigerator, has a main function for the control of ice making rate. Connected to an input stage of the controller 100 are a power supply unit 120, an operating unit 13 including buttons, etc., and an ice making compartment temperature sensor 140 to measure the internal temperature of the ice making compartment 15.

A cold air fan driver 150 is connected to an output stage of the controller 100, to drive the cold air fan 7.

When the user selects an operation mode associated with ice making by operating the operating unit 130, the controller 100 controls the rotating speed or operation rate of the cold air fan 7, taking into consideration the internal temperature of the ice making compartment 15 sensed by the ice making compartment temperature sensor 140.

The ice making operation mode includes a general ice making mode, a fast ice making mode, and an ice-making stop mode. The ice-making stop mode is a mode only for storage of ice.

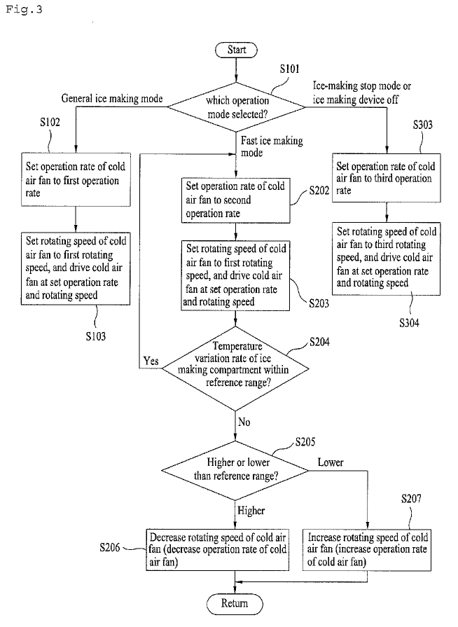

FIG. 3 illustrates an example process of ice making control. As shown in FIG. 3, the controller 100 continuously determines which operation mode is selected in accordance with a button depressing operation of the user (S101).

When it is determined, based on the ice making operation mode determination (S101), that the general ice making mode is selected, the controller 100 sets the operation rate of the cold air fan 7 to a first operation rate (S102). In this case, the controller 100 also sets the rotating speed of the cold air fan 7 to a first rotating speed, and then drives the cold air fan 7 at the set first operation rate and first rotating speed (S103).

On the other hand, if it is determined, based on the ice making operation mode determination (S101), that the fast ice making mode is selected, the controller 100 sets the operation rate of the cold air fan 7 to a second operation rate (S202).

The second operation rate has a higher value than the first operation rate. As such, the on-state time in a unit on/off period of the cold air fan 7 in the fast ice making mode is longer than that in the general ice making mode.

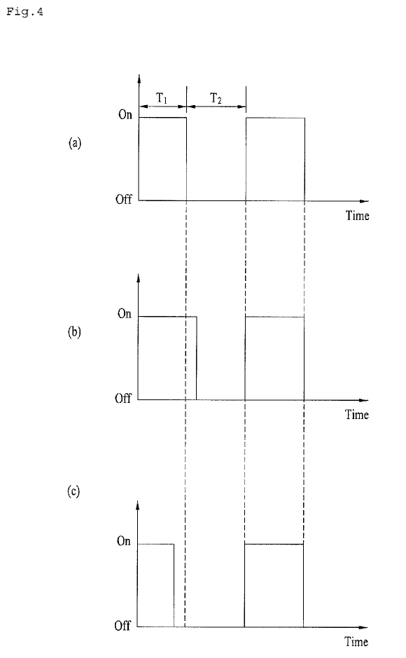

FIGS. 4(a) and 4(b) illustrate examples of operation rate. As shown, the operation rate of the cold air fan 7 is represented by a ratio of the on-state time T1 to the off-state time T2, and the operation rate in the fast ice making mode is higher than that in the general ice making mode.

Referring again to FIG. 3, the controller 100 also sets the rotating speed of the cold air fan 7 to the first rotating speed. That is, the controller 100 maintains the rotating speed at the first rotating speed, and then drives the cold air fan 7 at the set second operation rate and first rotating speed (S203).

Under the condition that the cold air fan 7 is driven at the second operation rate and first rotating speed, the controller 100 determines whether a temperature variation rate of the ice making compartment 15 is within a predetermined reference range, based on a temperature sensed by the ice making temperature sensor 140 (S204).

When it is determined that the temperature variation rate is outside the reference range, the controller 100 determines whether the temperature variation rate is higher or lower than the reference range (S205).

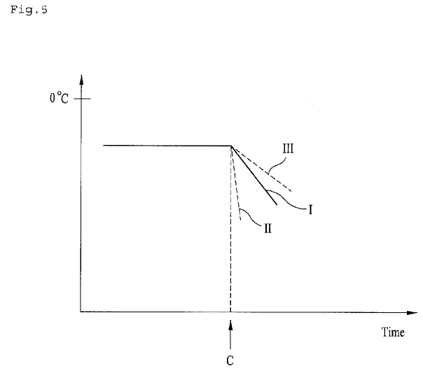

That is, when the operation mode of the ice making device 18 is changed to the fast ice making mode at a point C in FIG. 5, temperature variation occurring after the mode change should trace a line I, as shown in FIG. 5, in order to reduce the likelihood of (e.g., prevent) the ice making device 18 from operating erroneously due to abrupt temperature drop. The slope of the line I defines a set temperature variation rate.

If abrupt temperature drop occurs, as indicated by the line II, the controller 100 decreases the rotating speed of the cold air fan 7, to reduce the amount of cold air introduced into the ice making compartment 15 (S206). In this case, the temperature variation rate is shifted toward the line I. Accordingly, it may be possible to achieve fast ice making while avoiding abrupt temperature drop.

On the contrary, when the temperature is gently lowered, as indicated by the line III, it is difficult to achieve fast ice making. In this case, therefore, the amount of cold air introduced into the ice making compartment may be increased. To this end, the controller 100 increases the rotating speed of the cold air fan (S207).

In some implementations, the same effect may be obtained by increasing or decreasing the operation rate of the cold air fan 7, in place of increasing or decreasing the rotating speed of the cold air fan 7.

The reference internal temperature of the ice making compartment 15 in the fast ice making mode is −16° C. This temperature may be set to other values.

Meanwhile, when it is determined, based on the ice making operation mode determination (S101), that the ice-making stop mode is selected, or when the ice making device is turned off, it is unnecessary to carry out ice making. Of course, ice already accumulated in the ice storage box may be stored in a frozen state.

Since a reduced amount of cold air is required for the storage of ice in the frozen state, as compared to the general ice making mode, the amount of cold air introduced into the ice making compartment 15 may be lowered by reducing the operation rate and rotating speed of the cold air fan 7. In addition, reducing the operation rate and rotating speed of the cold air fan 7 may lower power consumption.

In this case, therefore, the controller 100 sets the operation rate of the cold air fan 7 to a third operation rate lower than the first operation rate (S303). Referring to the characteristics of the general ice making mode shown in FIG. 4(a) and the characteristics of the ice-making stop mode shown in FIG. 4(c), it can be seen that the on-state time in the unit on/off period of the cold air fan 7 in the ice-making stop mode is shorter than that in the general ice making mode.

Thus, the operation rate in the ice-making stop mode or in the off state of the ice making device is lower than that in the general ice making mode.

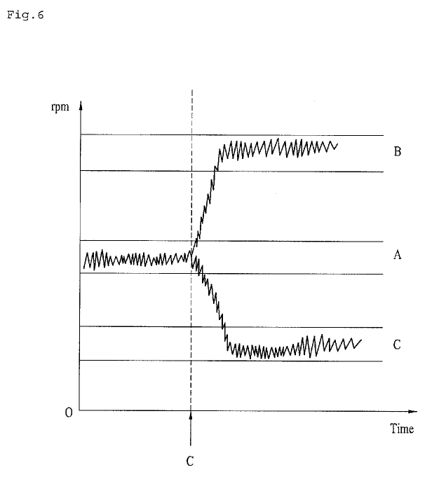

In some examples, when the ice making device, which operates in the general ice making mode, is changed in operation mode to the ice-making stop mode, or is turned off, the rotating speed of the ice making device is lowered to a third rotating speed C (S304). As shown in FIG. 6, the third rotating speed C is indicated in the form of a speed range including certain tolerance.

Thus, both the operation rate and the rotating speed are lowered in the ice-making stop mode or the off state of the ice making device 18, as compared to the general ice making mode and rapid ice making mode. Accordingly, the power consumption for driving the cold air fan 7 is lowered.

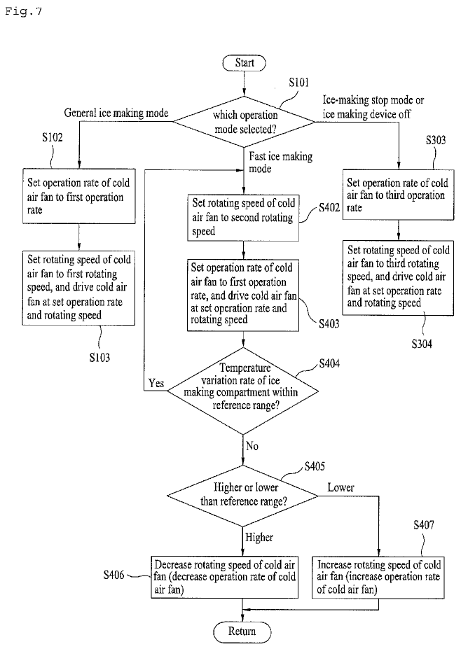

FIG. 7 illustrates an example operation to control the rotating speed of the cold air fan when the fast ice making mode is selected.

In this case, the control flow in the general ice making mode, ice-making stop mode, or off state of the ice making device 18 is identical to the control flow shown in FIG. 4, so no further description thereof will be given.

When it is determined, based on the ice making operation mode determination (S101), that the fast ice making mode is selected, the controller 100 sets the rotating speed of the cold air fan 7 to a second rotating speed higher than the first rotating speed (S402).

As shown in FIG. 6, the first rotating speed, which is designated by reference character “A”, corresponds to the rotating speed of the cold air fan 7 in the general ice making mode. When the operation mode of the ice making device 18 is changed to the fast ice making mode at a point C in FIG. 6, the rotating speed of the cold air fan 7 is increased to the second rotating speed, which is designated by reference character “B” in FIG. 6. In FIG. 6, each of the first and second rotating speeds A and B is indicated in the form of a speed range including certain tolerance.

As the rotating speed of the cold air fan 7 increases, the amount of cold air introduced into the ice making compartment 15 per unit time is increased. As a result, the internal temperature of the ice making compartment 15 is lowered.

In this case, the controller 100 also sets the operation rate of the cold air fan 7 to the first operation rate, that is, maintains the operation rate at the first operation rate, and then drives the cold air fan 7 at the set second rotating speed and first operation rate (S403). This is because, when even the operation rate increases, abrupt temperature variation occurs in the ice making compartment 15.

Under the condition that the cold air fan 7 is driven at the set operation rate and rotating speed, the controller 100 determines whether a temperature variation rate of the ice making compartment 15 is within a predetermined reference range, based on a temperature sensed by the ice making temperature sensor 140 (S404).

When it is determined that the temperature variation rate is outside the reference range, the controller 100 determines whether the temperature variation rate is higher or lower than the reference range (S405).

That is, when the operation mode of the ice making device 18 is changed to the fast ice making mode at the point C in FIG. 5, temperature variation occurring after the mode change should trace a line I, as shown in FIG. 5, in order to reduce the likelihood of (e.g., prevent) the ice making device 18 from operating erroneously due to abrupt temperature drop. The inclination of the line I illustrates a set temperature variation rate.

If abrupt temperature drop occurs, as indicated by the line II, the controller 100 decreases the rotating speed of the cold air fan 7, to reduce the amount of cold air introduced into the ice making compartment 15 (S406). In this case, the temperature variation rate is shifted toward the line I. Accordingly, it is possible to achieve fast ice making while avoiding abrupt temperature drop.

On the contrary, when the temperature is gently lowered, as indicated by the line III, it is difficult to achieve fast ice making. In this case, therefore, it is necessary to increase the amount of cold air introduced into the ice making compartment. To this end, the controller 100 increases the rotating speed of the cold air fan (S407).

Of course, the same effect may be obtained by increasing or decreasing the operation rate of the cold air fan 7, in place of increasing or decreasing the rotating speed of the cold air fan 7.

Thus, it is possible to decrease or increase the ice making rate by varying the operation rate or rotating speed of the cold air fan, and thus controlling the internal temperature variation of the ice making compartment. Even in the case in which it is unnecessary to carry out ice making, but storage of ice in a frozen state is needed, it is possible to appropriately vary the operation rate and rotating speed, and thus to reduce power consumption.

As apparent from the above description, the techniques described may provide an advantage in that it is possible to control an ice making speed by controlling the amount of cold air introduced into the ice making compartment.

In some implementations, it may be possible to considerably increase the ice making speed, while reducing the likelihood of (e.g., preventing) the internal temperature of the ice making compartment from being abruptly lowered. Thus, it may be possible to reduce the likelihood of (e.g., prevent) the constituent elements of the ice making device from operating erroneously due to abrupt temperature variation.

It will be understood that various modifications may be made without departing from the spirit and scope of the claims. For example, advantageous results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A method for controlling a refrigerator including a body, an evaporator arranged in the body, a cold air fan configured to move cold air generated around the evaporator, and an ice making compartment, into which cold air from the evaporator is introduced by the cold air fan, comprising:
receiving user input selecting an ice-making operation mode from among multiple, different ice-making operation modes that each define a different ice making speed;
determining, from among the multiple, different ice-making operation modes, which ice-making operation mode is selected based on the received user input; and
based on the determination of the selected ice-making operation mode, controlling an internal temperature of the ice making compartment to be appropriate for the selected ice-making operation mode by controlling at least one of an operation rate of the cold air fan and a rotating speed of the cold air fan.

2. The method according to claim 1, wherein:
receiving user input selecting an ice-making operation mode from among multiple, different ice-making operation modes that each define a different ice making speed comprises receiving user input selecting an ice-making operation mode from among a general ice making mode, a fast ice making mode defined to make ice within a shorter time than the general ice making mode, and a stop ice making mode in which ice making is stopped; and
controlling at least one of an operation rate of the cold air fan and a rotating speed of the cold air fan comprises, in response to a determination that the general ice making mode is selected, setting the operation rate of the cold air fan to a first operation rate, and setting the rotating speed of the cold air fan to a first rotating speed.

3. The method according to claim 2, wherein controlling at least one of an operation rate of the cold air fan and a rotating speed of the cold air fan comprises, in response to a determination that the fast ice making mode is selected, setting the operation rate of the cold air fan to a second operation rate that is higher than the first operation rate.

4. The method according to claim 3, wherein controlling at least one of an operation rate of the cold air fan and a rotating speed of the cold air fan comprises:
determining a variation rate of the internal temperature of the ice making compartment during the fast ice making mode;
comparing the variation rate of the internal temperature of the ice making compartment during the fast ice making mode to a predetermined reference range; and
controlling at least one of the operation rate of the cold air fan and the rotating speed of the cold air fan based on the comparison of the variation rate of the internal temperature of the ice making compartment during the fast ice making mode to the predetermined reference range.

5. The method of claim 4, wherein controlling at least one of the operation rate of the cold air fan and the rotating speed of the cold air fan based on the comparison of the variation rate of the internal temperature of the ice making compartment during the fast ice making mode to the predetermined reference range comprises decreasing the operation rate of the cold air fan when the comparison reveals that the variation rate of the internal temperature of the ice making compartment during the fast ice making mode is higher than the predetermined reference range.

6. The method according to claim 4, wherein controlling at least one of the operation rate of the cold air fan and the rotating speed of the cold air fan based on the comparison of the variation rate of the internal temperature of the ice making compartment during the fast ice making mode to the predetermined reference range comprises:
decreasing the rotating speed of the cold air fan from the set rotating speed when the comparison reveals that the variation rate of the internal temperature of the ice making compartment is higher than the predetermined reference range during the fast ice making mode; and
increasing the rotating speed of the cold air fan from the set rotating speed when the comparison reveals that the variation rate of the internal temperature of the ice making compartment is lower than the predetermined reference range during the fast ice making mode.

7. The method according to claim 2, wherein controlling at least one of an operation rate of the cold air fan and a rotating speed of the cold air fan comprises, in response to a determination that the fast ice making mode is selected, setting the rotating speed of the cold air fan to a second rotating speed that is higher than the first rotating speed.

8. The method according to claim 7, wherein controlling at least one of an operation rate of the cold air fan and a rotating speed of the cold air fan comprises:
determining a variation rate of the internal temperature of the ice making compartment during the fast ice making mode;
comparing the variation rate of the internal temperature of the ice making compartment during the fast ice making mode to a predetermined reference range; and
controlling at least one of the operation rate of the cold air fan and the rotating speed of the cold air fan based on the comparison of the variation rate of the internal temperature of the ice making compartment during the fast ice making mode to the predetermined reference range.

9. The method according to claim 8, wherein controlling at least one of the operation rate of the cold air fan and the rotating speed of the cold air fan based on the comparison of the variation rate of the internal temperature of the ice making compartment during the fast ice making mode to the predetermined reference range comprises decreasing the rotating speed of the cold air fan from the set rotating speed when the comparison reveals that the variation rate of the internal temperature of the ice making compartment is higher than the predetermined reference range during the fast ice making mode.

10. The method according to claim 8, wherein controlling at least one of the operation rate of the cold air fan and the rotating speed of the cold air fan based on the comparison of the variation rate of the internal temperature of the ice making compartment during the fast ice making mode to the predetermined reference range comprises decreasing the operation rate of the cold air fan from the set operation rate when the comparison reveals that the variation rate of the internal temperature of the ice making compartment is higher than the predetermined reference range during the fast ice making mode.

11. The method according to claim 2, wherein controlling at least one of an operation rate of the cold air fan and a rotating speed of the cold air fan comprises, in response to a determination that the stop ice making mode is selected, setting the operation rate of the cold air fan to a third operation rate that is lower than the first operation rate.

12. The method according to claim 2, wherein controlling at least one of an operation rate of the cold air fan and a rotating speed of the cold air fan comprises, in response to a determination that the stop ice making mode is selected, setting the rotating speed of the cold air fan to a third rotating speed that is lower than the first rotating speed.

13. The method according to claim 2, wherein controlling an internal temperature of the ice making compartment to be appropriate for the selected ice-making operation mode comprises, in response to a determination that the fast ice making mode is selected, controlling an internal temperature of the ice making compartment to be −16° C.

14. A method for controlling a refrigerator including a cold air fan configured to move cold air from an evaporator, an ice making compartment, into which cold air moved by the cold air fan is introduced, and an ice making device installed in the ice making compartment, comprising:
receiving user input selecting from among a first ice making mode, a second ice making mode, and a third ice making mode, the first ice making mode defining a relatively slow ice making speed, the second ice making mode defining a relatively medium ice making speed, and the third ice making mode defining a relatively fast ice making speed;
determining whether the first ice making mode, the second ice making mode, or the third ice making mode has been selected based on the received user input;
in response to a determination that the first ice making mode has been selected, controlling an internal temperature of the ice making compartment to a first temperature by controlling an operation rate of the cold air fan to be a first operation rate and controlling a rotating speed of the cold air fan to be a first rotating speed;
in response to a determination that the second ice making mode has been selected, controlling the internal temperature of the ice making compartment to a second temperature that is lower than the first temperature by controlling the operation rate of the cold air fan to be a second operation rate and controlling the rotating speed of the cold air fan to be a second rotating speed; and
in response to a determination that the third ice making mode has been selected, controlling the internal temperature of the ice making compartment to a third temperature that is lower than the second temperature by controlling the operation rate of the cold air fan to be a third operation rate and controlling the rotating speed of the cold air fan to be a third rotating speed.

15. The method of claim 14, wherein receiving user input selecting from among the first ice making mode, the second ice making mode, and the third ice making mode comprises receiving user input selecting from among a stop ice making mode, a general ice making mode, and a fast ice making mode.

16. The method of claim 14, wherein the first operation rate, the second operation rate, and the third operation rate are the same, the first rotating speed is slower than the second rotating speed, and the second rotating speed is slower than the third rotating speed.

17. The method of claim 14, wherein the first rotating speed, the second rotating speed, and the third rotating speed are the same, the first operation rate is lower than the second operation rate, and the second operation rate is lower than the third operation rate.

18. The method of claim 14, wherein the second rotating speed and the third rotating speed are the same, the first rotating speed is slower than the second rotating speed and the third rotating speed, the first operation rate and the second operation rate are the same, and the first operation rate and the second operation rate are lower than the third operation rate.

19. A method for controlling a refrigerator including a cold air fan configured to move cold air from an evaporator, an ice making compartment, into which cold air moved by the cold air fan is introduced, and an ice making device installed in the ice making compartment, comprising:
decreasing an internal temperature of the ice making compartment to promote faster ice making by controlling at least one of an operation rate of the cold air fan and a rotating speed of the cold air fan;
determining a variation rate of the internal temperature of the ice making compartment while decreasing the internal temperature of the ice making compartment to promote faster ice making;
comparing the variation rate of the internal temperature of the ice making compartment while decreasing the internal temperature of the ice making compartment to promote faster ice making to a predetermined reference range; and
adjusting at least one of the operation rate of the cold air fan and the rotating speed of the cold air fan based on the comparison of the variation rate of the internal temperature of the ice making compartment while decreasing the internal temperature of the ice making compartment to promote faster ice making to the predetermined reference range.

20. The method according to claim 19, wherein adjusting at least one of the operation rate of the cold air fan and the rotating speed of the cold air fan comprises:
decreasing the rotating speed of the cold air fan when the comparison reveals that the variation rate of the internal temperature of the ice making compartment is higher than the predetermined reference range; and
increasing the rotating speed of the cold air fan when the comparison reveals that the variation rate of the internal temperature of the ice making compartment is lower than the predetermined reference range.
